(19) United States
(12) Patent Application Publication
(10) Pub. No.: US 2021/0049597 A1
(43) Pub. Date: Feb. 18, 2021

(54) PREDICTING SUCCESSFUL EXEMPTIONS TO STRONG AUTHENTICATION REQUIREMENTS

(71) Applicant: Amazon Technologies, Inc., Seattle, WA (US)

(72) Inventors: ROHIT KUMRA, NEW DELHI (IN); CATALIN CONSTANTIN, SEATTLE, WA (US); NICOLAS GAIVIRONSKY, VANCOUVER, BC (CA); DENIS EYDELMAN, COQUITLAM (CA)

(21) Appl. No.: 16/543,283

(22) Filed: Aug. 16, 2019

(51) Int. Cl. G06Q 20/38; H04L 29/06; G06Q 40/02; G06Q 20/40

(52) U.S. Cl. CPC G06Q 20/3821; G06Q 20/4016; G06Q 40/025; H04L 63/08

(57) ABSTRACT

Disclosed are various embodiments for predicting successful exemptions to strong authentication requirements. A first payment transaction associated with a first user is submitted for processing by a particular payment issuer along with a request for an exemption from an authentication requirement. It is determined whether the first payment transaction was successfully processed. Subsequently, it is determined whether to include the request for the exemption from the authentication requirement for a second payment transaction associated with a second user in submitting the second payment transaction for processing with the particular payment issuer based at least in part on whether the first payment transaction was successfully processed.

### BACKGROUND

With the advent of chip-based credit cards, most fraud associated with credit card transactions is associated with transactions where the physical card is not present for verification by the merchant and card issuer. For example, transactions over the telephone or via the Internet are card-not-present (CNP) transactions. In CNP transactions, it is important to authenticate users with a high degree of confidence. Three-domain secure (3DS) is a protocol that enables users to authenticate themselves with the card issuer when making CNP transactions. 3DS with multi-factor authentication is one form of a strong customer authentication (SCA). SCA is a requirement of the Payment Service Directive 2 (PSD2) in the European Union, although PSD2 provides for exemptions from SCA under certain circumstances.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of a networked environment according to various embodiments of the present disclosure.

FIG. 2 is a drawing of a data store used in a computing environment in the networked environment of FIG. 1 according to various embodiments of the present disclosure.

FIGS. 3A-3C are flowcharts illustrating examples of functionality implemented as portions of a payment handling system executed in a computing environment in the networked environment of FIG. 1 according to various embodiments of the present disclosure.

FIGS. 4A-4C are sequence diagrams that provide examples of the interaction among the client application, the payment handling service, and the payment issuer system in the networked environment of FIG. 1 according to various embodiments of the present disclosure.

FIG. 5 is a schematic block diagram that provides one example illustration of a computing environment employed in the networked environment of FIG. 1 according to various embodiments of the present disclosure.

### DETAILED DESCRIPTION

The present disclosure relates to predicting successful transaction risk analysis exemptions to strong authentication requirements. The Payment Service Directive 2 (PSD2) in the European Union generally requires the use of strong customer authentication (SCA) in card-not-present (CNP) transactions in order to reduce fraud. One form of SCA involves using the three-domain secure (3DS) protocol to redirect users to a system operated by the payment network or card issuer for a second level of authentication on top of whatever authentication was performed by the merchant. For instance, the card issuer may require the user to provide a one-time password that was sent to the user's telephone number or email address that is on file with the card issuer. Alternatively, or additionally, the card issuer may require the user to supply a password that was previously configured by the user with the card issuer in association with a specific payment card.

When SCA is employed, the user has already undergone a merchant-specific authentication process, which may involve providing a password, answering knowledge-based questions, providing a one-time password, and/or meeting other authentication challenges. The risk management systems of the merchant may require various authentication challenges based upon a risk level determined for the transaction. For example, a user may have to reenter a stored credit card number when having items shipped to a new shipping address. After these challenges are completed, SCA comes into play.

Although SCA may assist in reducing payment instrument fraud, it also increases user friction in the checkout or payment process. The user may have already responded successfully to one or more authentication challenges by the merchant, and further challenges slow down or delay the payment process. Further, with 3DS, users may be presented with a user interface that is controlled by the card issuer or payment network instead of the merchant, resulting in an inconsistent, unfamiliar, and perhaps confusing user interface in the midst of the payment process. Also, by redirecting client devices to a different network, users may experience additional network latencies and failures. Thus, from the merchant's perspective, it may be generally desirable to avoid SCA where possible.

PSD2 provides for several types of exemptions from SCA. One such exemption is based on a transaction risk analysis (TRA). With TRA exemptions, a merchant can request an exemption from SCA for a transaction that the merchant deems low risk and which is under a certain monetary threshold. However, the overall fraud rate for that type of transaction with the merchant cannot exceed a predefined threshold in order for the merchant to qualify for the SCA-exempt transaction. In addition, the card issuer can arbitrarily choose not to support the TRA exemption or to deny the TRA exemption based on criteria not transparent to the merchant. Denial of a requested TRA exemption to SCA can result in a denied transaction, which can further delay or interrupt the payment process beyond merely requiring SCA in the first place.

Various embodiments of the present disclosure introduce approaches to predict when a TRA exemption request will be successful, so that a TRA exemption can be requested if it is likely to succeed and avoided if it is not likely to succeed. If a TRA exemption is not likely to succeed for a transaction, a different type of exemption can be requested, or the merchant may allow SCA to proceed. The approaches can employ machine learning to develop accurate predictions even where the card-issuer-specific criteria for denial of a TRA exemption are not known to the merchant and where such criteria may change over time. Ultimately, a large majority of the merchant's transactions may qualify as SCA exempt through the TRA exemption, and successfully identifying such eligible transactions through the approaches described herein can result in an improved user experience.

As one skilled in the art will appreciate in light of this disclosure, certain embodiments may be capable of achieving certain advantages, including some or all of the following: (1) improving the performance of a computing system by reducing network latency associated with communicating with a third-party system to enable SCA; (2) improving reliability of the computing system by avoiding communication over a third-party network to perform SCA; (3) improving security of a computer network by limiting the transmission of personal information to perform SCA; (4) improving the functioning of the computing system through a more streamlined payment process for low-risk transactions that reduces user frustration; (5) enhancing the user experience by avoiding third-party SCA user interfaces with an inconsistent look-and-feel; (6) avoiding a redirection to a third-party system for authentication, which conserves computing resources (e.g. processing utilization, memory utilization, network traffic, data payloads, etc.) on multiple systems, and improves the user's security by reducing an attack vector by not redirecting to another site (despite best efforts, the payment issuer system, the client computing device, and/or other intermediate devices may have malicious software unintentionally installed); and so forth. In the following discussion, a general description of the system and its components is provided, followed by a discussion of the operation of the same.

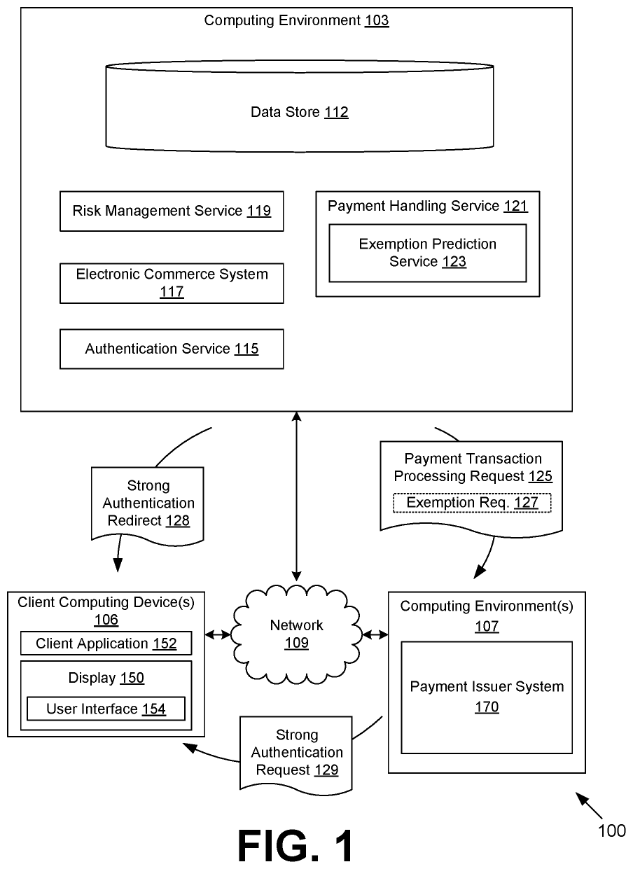

With reference to FIG. 1, shown is a networked environment 100 according to various embodiments. The networked environment 100 includes a computing environment 103, one or more client computing devices 106, and one or more computing environments 107, which may be in data communication via a network 109. The network 109 includes, for example, the Internet, intranets, extranets, wide area networks (WANs), local area networks (LANs), wired networks, wireless networks, cable networks, satellite networks, or other suitable networks, etc., or any combination of two or more such networks.

The computing environment 103 may be operated by or on behalf of a merchant or other entity operating an electronic commerce network site, a network site accepting donations on behalf of others, a network site accepting bill payments, and/or other network sites that involve payments by users. The computing environment 103 may comprise, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may comprise a hosted computing resource, a grid computing resource, and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 112 that is accessible to the computing environment 103. The data store 112 may be representative of a plurality of data stores 112 as can be appreciated. The data stored in the data store 112, for example, is associated with the operation of the various applications and/or functional entities described below.

The components executed on the computing environment 103, for example, include an authentication service 115, an electronic commerce system 117, a risk management service 119, a payment handling service 121, and other applications, services, processes, systems, engines, or functionality not discussed in detail herein.

The authentication service 115 is executed to authenticate users for access to resources on the computing environment 103, such as user account resources. The users are also authenticated for an ability to place orders or otherwise initiate payment transactions via the computing environment 103. In authenticating users, the authentication service 115 confirms to a degree of confidence that an individual user is who he or she claims to be. In this regard, the user may be asked to respond to one or more different authentication challenges, which may involve providing a password, answering one or more knowledge-based questions, providing a one-time password sent through a verified channel of communication such as an email address or telephone number, performing biometric recognition, and so forth. Authentication factors employed may include knowledge-based factors, possession-based factors, and biometric factors.

The electronic commerce system 117 is executed to facilitate electronic commerce transactions via a network site. To this end, the electronic commerce system 117 may generate network pages or other forms of network content that enable users to browse or search for items of interest. The electronic commerce system 117 may allow users to place orders for items and then initiate payment for the orders. In various embodiments, the electronic commerce system 117 may include a shopping cart system whereby users add items of interest to an electronic shopping cart, and an order pipeline whereby users can consummate orders and select methods of payment.

The risk management service 119 is executed to perform a risk analysis with respect to users' interactions with the electronic commerce system 117 and any payment transactions. In this regard, the risk management service 119 may generate a risk score based on various criteria. Non-limiting examples of factors that may be considered in generating a risk score may include authentication failures and number of authentication attempts, geographic location of the client computing device 106, shipping address for an order, click trails or other behavior data, types of items ordered compared to historical orders, and so on. Comparison of such risk score to a risk threshold indicating the risk is relatively high may require a user to be authenticated via a stronger form of authentication. By contrast, if the risk score is relatively low, additional authentication factors may be avoided.

The payment handling service 121 is executed to handle payment processing from the side of the merchant or other entity operating the computing environment 103. The payment handling service 121 may handle payments for a variety of payment instruments, such as credit cards, debit cards, stored value cards, bank accounts, virtual wallets, and/or other payment instruments. The payment handling service 121 may handle payment preauthorizations, authorizations, and/or settlements. To this end, the payment handling service 121 may communicate with systems of the computing environment 107 to ensure that payment transactions are authorized.

The payment handling service 121 may send a payment transaction processing request 125 to a payment gateway or processor in the computing environment 107. The payment transaction processing request 125 may include a variety of information about the payment transaction, including user name, payment instrument identifying information, shipping address information, items ordered, values, and so forth. In some cases, the payment transaction processing request 125 will include an exemption request 127 to exempt the particular payment transaction from an authentication requirement, such as strong customer authentication.

In one implementation, the payment transaction processing request 125 is an up to 65535 byte field having four subfields. The first subfield may specify a length in two bytes, indicating the number of bytes in the field. The second subfield may be a single byte and contain a hexadecimal value that identifies the tag/length/value (TLV) data that follows. The third subfield may be a two-byte subfield that specifies the total length of the TLV fields in this payment transaction processing request 125. The length may be variable depending on the data that follows. In positions 4-65535, the TLV data is presented. Each subfield has a defined tag, length, and value. The tag is used in conjunction with the dataset identifier value. The dataset subfields may be present in any order with other TLV subfields. For example, an exemption request 127 may be indicated by sending tag 947D, with length of 1, and value 0 if the exemption is not applied, and value 1 if the exemption is applied. Alternatively, the payment transaction processing request 125 may be in extensible markup language (XML), JavaScript object notation (JSON), and/or other structured data formats.

If the payment transaction is not exempt from the authentication requirement, the payment handling service 121 may send a strong authentication redirect 128 to the client computing device 106. The strong authentication redirect 128 then causes the client computing device 106 to access a uniform resource locator (URL) on the computing environment 107 that results in a strong authentication request 129 being sent from the computing environment 107 to the client computing device 106. For example, the strong authentication redirect 128 may correspond to a network page that includes an IFRAME element that refers to the URL.

The payment handling service 121 may include or function alongside an exemption prediction service 123. The exemption prediction service 123 is executed to predict whether an exemption from the authentication requirement will be permitted for a particular payment transaction. The exemption may be supported by some payment issuers and not others, while payment issuers supporting the exemption may establish their own criteria for accepting the exemption. This criteria may be inaccessible to or otherwise unknown to the merchant. Further, support for the exemption and criteria for the exemption may change over time among different payment issuers. The exemption prediction service 123 may use a machine learning model and/or a trial-and-error approach in order to create a rule set to predict for which types of payment transactions the exemption should be requested.

The client computing device 106 is representative of a plurality of client devices that may be coupled to the network 109. The client computing device 106 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The client computing device 106 may include a display 150. The display 150 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client computing device 106 may be configured to execute various applications such as a client application 152 and/or other applications. The client application 152 may be executed in a client computing device 106, for example, to access network content served up by the computing environment 103 and/or other servers, thereby rendering a user interface 154 on the display 150. To this end, the client application 152 may comprise, for example, a browser, a dedicated application, etc., and the user interface 154 may comprise a network page, an application screen, etc. The client computing device 106 may be configured to execute applications beyond the client application 152 such as, for example, email applications, social networking applications, word processors, spreadsheets, and/or other applications.

The computing environment 107 may be operated by or on behalf of a payment acquirer and/or payment issuer, which may include banks and other financial institutions, payment card issuers, payment gateways, and so forth. The computing environment 107 may comprise, for example, a server computer or any other system providing computing capability. Alternatively, the computing environment 107 may employ a plurality of computing devices that may be arranged, for example, in one or more server banks or computer banks or other arrangements. Such computing devices may be located in a single installation or may be distributed among many different geographical locations. For example, the computing environment 107 may include a plurality of computing devices that together may comprise a hosted computing resource, a grid computing resource, and/or any other distributed computing arrangement. In some cases, the computing environment 107 may correspond to an elastic computing resource where the allotted capacity of processing, network, storage, or other computing-related resources may vary over time.

Various applications and/or other functionality may be executed in the computing environment 107 according to various embodiments. Also, various data may be stored in a data store that is accessible to the computing environment 107. The components executed on the computing environment 107, for example, include a payment issuer system 170 and other applications, services, processes, systems, engines, or functionality not discussed in detail herein. The payment issuer system 170 is executed to receive payment transaction processing requests 125 from the computing environment 103 or other merchants and to authorize or deny the requests. In some implementations, the payment transaction processing requests 125 may be received by the payment issuer system 170 by way of a payment acquirer, a payment gateway, or some other intermediate server that may be operated by a different entity than the payment issuer. This intermediate server can then forward the payment transaction processing requests 125 to the payment issuer system 170. The payment issuer system 170 may confirm that funds or credit is available for a given payment instrument such that the payment transaction is authorized to proceed. Further, the payment issuer system 170 may perform its own risk analysis to determine whether to authorize or deny the payment transaction.

In various implementations, the payment issuer system 170 may include one or more access control services that may be configured to perform strong customer authentication by sending a strong authentication request 129 to the client computing device 106. For example, the client computing device 106 may be redirected by the payment handling service 121 during a checkout workflow via the strong authentication redirect 128 to perform strong authentication with the payment issuer system 170. In one implementation, the payment handling service 121 may use an IFRAME element within a hypertext markup language (HTML) page to display the strong authentication request 129.

In the strong authentication request 129, the user may be asked to respond to an authentication challenge additional to previous challenges via the authentication service 115 in the computing environment 103. If a strong authentication request 129 is sent, approval of the payment transaction may be contingent upon the user successfully responding to the authentication challenge. The strong authentication request 129 may be generated according to a protocol such as three-domain secure (3DS) 2.0. Otherwise, the payment handling service 121 may request an exemption to the authentication requirement, and the payment issuer system 170 may choose to grant the exemption or deny the transaction.

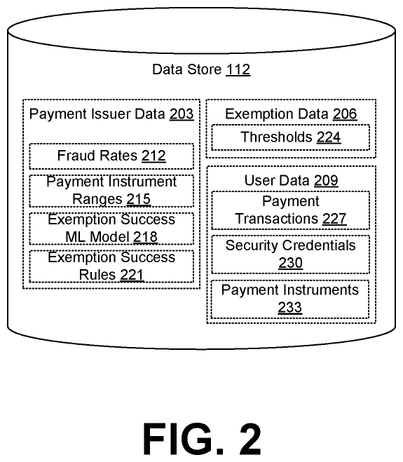

Moving on to FIG. 2, shown is an example of the data store 112 from the computing environment 103 (FIG. 1). The data stored in the data store 112 includes, for example, payment issuer data 203, exemption data 206, user data 209, and potentially other data. The payment issuer data 203 includes data with respect to individual payment issuers of potentially a plurality of payment issuers. The payment issuer data 203 may include fraud rates 212, payment instrument ranges 215, an exemption success machine learning model 218, exemption success rules 221, and/or other data.

The fraud rates 212 indicate rates of chargebacks or other types of payment instrument fraud for payment instruments issued by the payment issuer. The fraud rates 212 may be significant in determining which payment transactions are eligible for exemption. For example, different transaction value thresholds or tiers of exemption eligibility may be established for different ranges of fraud rates 212.

The payment instrument ranges 215 are used to identify a particular payment issuer from the payment instrument data. For example, a payment card number may include a bank identification number (BIN) that corresponds to a particular payment issuer.

The exemption success machine learning model 218 corresponds to a machine learning model used to predict the likelihood of success for an exemption request 127 (FIG. 1) for a particular payment transaction processing request 125 (FIG. 1). The exemption success machine learning model 218 is specific to a particular payment issuer and trained on the outcome of past exemption requests 127 for payment transactions with the particular payment issuer in correlation with one or more characteristics of the corresponding user and/or one or more characteristics of the corresponding transaction. In various embodiments, the exemption success machine learning model 218 may employ a regression model, a clustering analysis, a random forest technique, a supervised learning technique, and/or other machine learning techniques.

The exemption success rules 221 can be used to determine whether to include an exemption request 127 for a particular payment transaction processing request 125 given characteristics of the payment transaction and/or characteristics of the user. The exemption success rules 221 are specific to a particular payment issuer. The exemption success rules 221 can be automatically generated based on the exemption success machine learning model 218 and/or on the basis of trial-and-error testing of exemption requests 127 for a particular payment issuer. Alternatively, or additionally, one or more of the exemption success rules 221 may be manually configured.

The exemption data 206 describes various exemptions to authentication requirements, including the transaction risk assessment (TRA) exemption. The exemption data 206 may include one or more thresholds 224, which may control whether an exemption is available. For example, an exemption may be available for transactions having a value at or below a certain threshold 224, but not available for values exceeding the threshold 224. Multiple thresholds 224 may be established. For example, a high value threshold 224 may be established for merchants associated with a relatively high fraud rate 212, while a low value threshold 224 may be established for merchants associated with a relatively low fraud rate 212.

The user data 209 includes data associated with user accounts. The user data 209 may include payment transactions 227, security credentials 230, payment instruments 233, and/or other data. The payment transactions 227 are each associated with a certain value and a payment instrument 233, and may be to purchase one or more items, rent one or more items, donate to an individual or group, pay a bill, pay another person, and so forth. The security credentials 230 are used to authenticate users and can include passwords, one-time passwords, answers to knowledge-based questions, voice recognition profiles, face recognition profiles, fingerprint recognition profiles, and so forth. The payment instruments 233 correspond to methods for making an electronic payment. Such payment instruments 233 can include bank accounts, electronic wallets, stored value cards, credit cards, debit cards, and so forth.

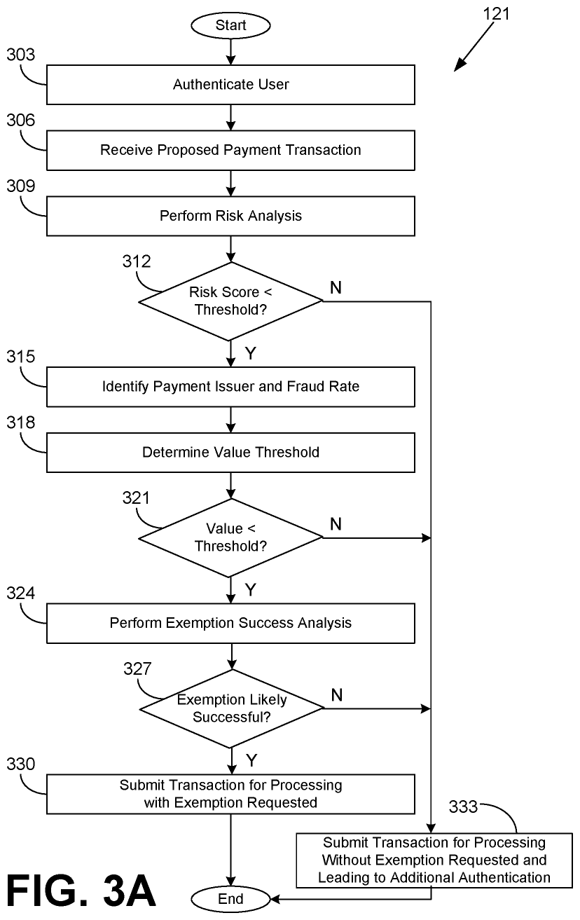

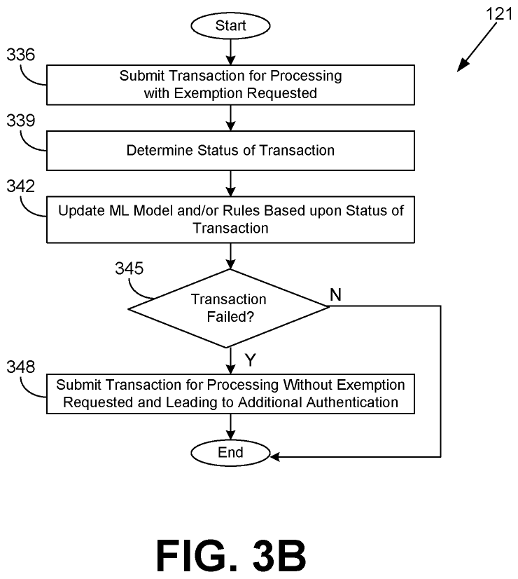

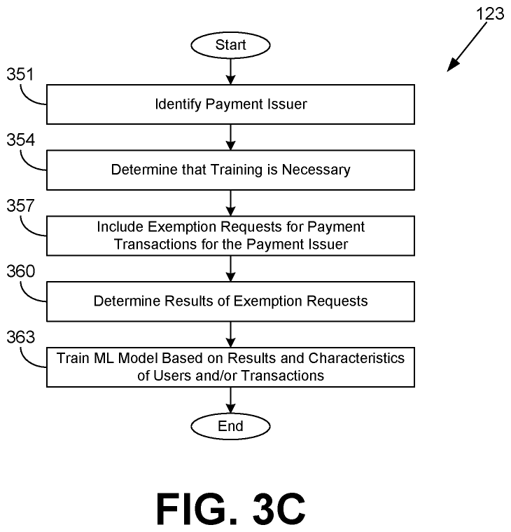

Referring next to FIG. 3A, shown is a flowchart that provides one example of the operation of a portion of the payment handling service 121 according to various embodiments. It is understood that the flowchart of FIG. 3A provides merely an example of the many different types of functional arrangements that may be employed to implement the operation of the portion of the payment handling service 121 as described herein. As an alternative, the flowchart of FIG. 3A may be viewed as depicting an example of elements of a method implemented in the computing environment 103 (FIG. 1) according to one or more embodiments.

Beginning with box 303, the payment handling service 121 authenticates the user at a client computing device 106 (FIG. 1) to a desired authentication level using the authentication service 115 (FIG. 1). The user may have to supply one or more security credentials 230 (FIG. 2) to answer one or more authentication challenges.

In box 306, the payment handling service 121 receives information regarding a proposed payment transaction 227 (FIG. 2). For example, the user may have requested to place an order for an item via an electronic commerce system 117 (FIG. 1), donate a sum of money, pay a bill, or perform some other transaction.

In box 309, the payment handling service 121 has a risk analysis performed on the payment transaction 227 performed by the risk management service 119 (FIG. 1). The risk management service 119 may examine a multitude of different signals or characteristics associated with the payment transaction 227, including, for example, the network address of the client computing device 106, the geographic location of the client computing device 106, the shipping address, the value of the payment transaction 227, and so forth, in order to ascertain a potential risk of fraud. The output of the risk analysis may be a risk score.

In box 312, the payment handling service 121 determines whether the risk score determined by the risk management service 119 is at or below a threshold 224 (FIG. 2) established as a minimum risk score to qualify for an exemption from an authentication requirement of the payment issuer. If the risk score is at or below the threshold 224, the payment handling service 121 continues from box 312 to box 315.

In box 315, the payment handling service 121 identifies the payment issuer for the payment transaction 227 and the corresponding fraud rate 212 (FIG. 2) from previous payment transactions with that payment issuer. The payment issuer may be identified, for example, by comparing a BIN of the payment instrument 233 (FIG. 2) with a payment instrument range 215 (FIG. 2) associated with the payment issuer.

In box 318, the payment handling service 121 determines a value threshold 224 for the exemption given the payment issuer and the corresponding fraud rate 212. For example, multiple value thresholds 224 may be configured and one may be selected based upon the corresponding fraud rate 212.

In box 321, the payment handling service 121 determines whether a value of the payment transaction 227 is at or below the determined value threshold 224. If the value of the payment transaction 227 is at or below the determined value threshold 224, the payment handling service 121 continues from box 321 to box 324.

In box 324, the payment handling service 121 performs an exemption success analysis using the exemption prediction service 123 (FIG. 1), which uses exemption success rules 221 (FIG. 2) and/or an exemption success machine learning model 218 (FIG. 2) to determine whether an exemption for this particular payment transaction 227 is likely to be successful for the given payment issuer. The characteristics of the payment transaction 227 and/or the user may be parameters considered. In some cases, the exemption prediction service 123 may generate a confidence score indicating a likelihood of success. In some implementations, the exemption prediction service 123 may predict an undocumented maximum value threshold that is likely to be enforced by the payment issuer system 170 on the given payment transaction 227 in order for an exemption request 127 to be approved. The value for the payment transaction 227 is then compared to this predicted threshold, and an exemption request 127 is submitted only if the value is below the predicted threshold.

In box 327, the payment handling service 121 determines whether an exemption from an authentication requirement of the payment issuer is likely to be successful. For example, the payment handling service 121 may compare a confidence score to a threshold 224 for likely success, or may compare a transaction value to a threshold 224. If an exemption is likely to be successful, the payment handling service 121 continues from box 327 to box 330.

In box 330, the payment handling service 121 submits the payment transaction 227 for processing with an exemption request 127 (FIG. 1). To this end, the payment handling service 121 may send a payment transaction processing request 125 (FIG. 1) including an exemption request 127 via the network 109 (FIG. 1) to a payment issuer system 170 (FIG. 1). Thereafter, the operation of the portion of the payment handling service 121 ends.

If the payment handling service 121 determines in box 312 that the risk score exceeds the risk threshold, if the payment handling service 121 determines in box 321 that the value of the payment transaction 227 exceeds the value threshold 224, or if the payment handling service 121 determines in box 327 that an exemption is unlikely to be successful, the payment handling service 121 instead transitions to box 333. In box 333, the payment handling service 121 submits the payment transaction 227 for processing without an exemption request 127 and leading to additional authentication of the user on behalf of the payment issuer. To this end, the payment handling service 121 may send a payment transaction processing request 125 without an exemption request 127 via the network 109 to a payment issuer system 170. The payment handling service 121 may also redirect the client application 152 (FIG. 1) to the payment issuer system 170 such that the payment issuer system 170 presents a strong authentication request 129 (FIG. 1) to the user via the client application 152. Thereafter, the operation of the portion of the payment handling service 121 ends.

Moving on to FIG. 3B, shown is a flowchart that provides one example of the operation of a portion of the payment handling service 121 according to various embodiments. It is understood that the flowchart of FIG. 3B provides merely an example of the many different types of functional arrangements that may be employed to implement the operation of the portion of the payment handling service 121 as described herein. As an alternative, the flowchart of FIG. 3B may be viewed as depicting an example of elements of a method implemented in the computing environment 103 (FIG. 1) according to one or more embodiments.

Beginning with box 336, the payment handling service 121 submits a payment transaction processing request 125 (FIG. 1) to a payment issuer system 170 (FIG. 1) via the network 109 (FIG. 1) for processing with an exemption request 127 (FIG. 1). The payment issuer may choose to accept or reject the exemption request 127 based on a rule set unknown to the payment handling service 121. In some cases, the payment issuer may simply not support the exemption at all. In box 339, the payment handling service 121 determines the status of the payment transaction 227 (FIG. 2). For example, the payment issuer system 170 may return a status of authorized or a status of denied.

In box 342, the payment handling service 121 proceeds to update the exemption success machine learning model 218 (FIG. 2) and/or the exemption success rules 221 (FIG. 2) based at least in part on whether the exemption request 127 (and consequently the payment transaction processing request 125) is authorized or denied. If the exemption request 127 is authorized, this strengthens the determination previously made by the exemption success machine learning model 218 and/or the exemption success rules 221. By contrast, if the exemption request 127 is denied, this contradicts the determination previously made by the exemption success machine learning model 218 and/or the exemption success rules 221. Both situations can be leveraged to improve the determinations made by exemption prediction service 123 (FIG. 1) from the exemption success machine learning model 218 and/or the exemption success rules 221.

In box 345, the payment handling service 121 determines whether the payment transaction processing request 125 failed due to the exemption request 127. For example, the payment issuer system 170 may return a flag indicating that the exemption request 127 was the cause of the denial of the payment transaction processing request 125. If so, the payment handling service 121 may retry the payment transaction processing request 125 but without including the exemption request 127 in box 348. This leads to additional authentication of the user on behalf of the payment issuer. Thereafter, the operation of the portion of the payment handling service 121 ends.

Turning now to FIG. 3C, shown is a flowchart that provides one example of the operation of a portion of the exemption prediction service 123 according to various embodiments. It is understood that the flowchart of FIG. 3C provides merely an example of the many different types of functional arrangements that may be employed to implement the operation of the portion of the exemption prediction service 123 as described herein. As an alternative, the flowchart of FIG. 3C may be viewed as depicting an example of elements of a method implemented in the computing environment 103 (FIG. 1) according to one or more embodiments.

Beginning with box 351, the exemption prediction service 123 identifies a payment issuer for which exemption predictions are to be determined. In box 354, the exemption prediction service 123 determines that training of an exemption success machine learning model 218 (FIG. 2) is necessary for the particular payment issuer.

In box 357, the exemption prediction service 123 allows exemption requests 127 (FIG. 1) to be included in payment transaction processing requests 125 (FIG. 1) destined for the payment issuer. This results in a trial-and-error approach until the exemption success machine learning model 218 is trained. In some cases, during initial training, payment transactions are sampled to a predetermined volume to avoid always requesting exemptions when the other criteria are met (i.e., risk determined by the risk management service 119 (FIG. 1) and transaction value in view of fraud rates 212 (FIG. 2)).

In box 360, the exemption prediction service 123 determines the results of the exemption requests 127. In box 363, the exemption prediction service 123 trains the exemption success machine learning model 218 based at least in part on the results and one or more characteristics of the users and/or the payment transactions 227 (FIG. 2). For example, the training data may be fed into a regression model, a clustering analysis, a random forest model, or a supervised learning model. The regression model may be used to estimate the relationships between the different signals or characteristics associated with the payment transactions 227 and the end results of the exemption being approved or denied. The clustering analysis may be used to identify types or clusters of payment transactions 227 for which the exemption is approved or denied. Supervised learning may be used for payment instruments 233 (FIG. 2) issued by a payment issuer by training the pattern that is observed across the payment instruments 233 issued by the payment issuer. A random forest technique may be used in the initial data analysis while building data sets for payment transactions 227 happening for the payee entity or merchant.

In one scenario, if all of the exemption requests 127 have failed during the learning period, it may be ascertained that the exemption is simply not supported, and an exemption success rule 221 (FIG. 2) can be established indicating no chance of success for the exemption for the given payment issuer. Thereafter, the operation of the exemption prediction service 123 ends.

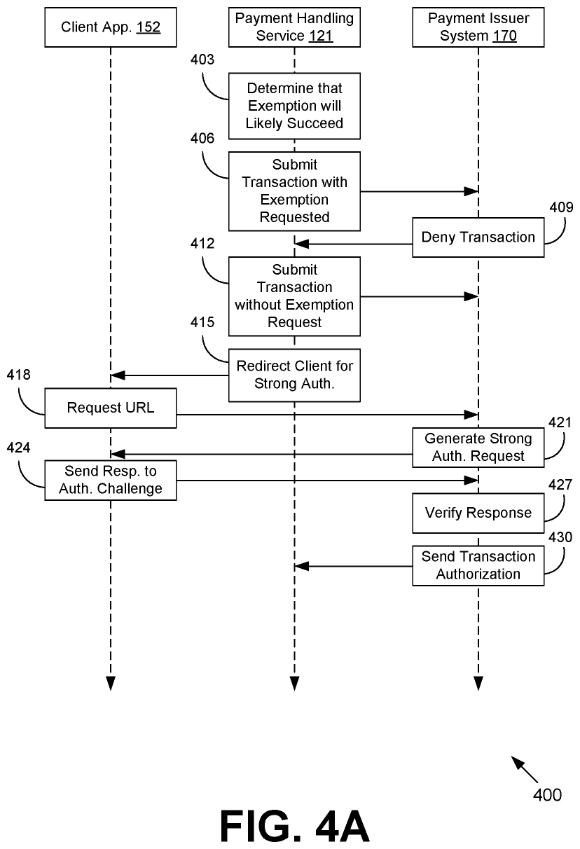

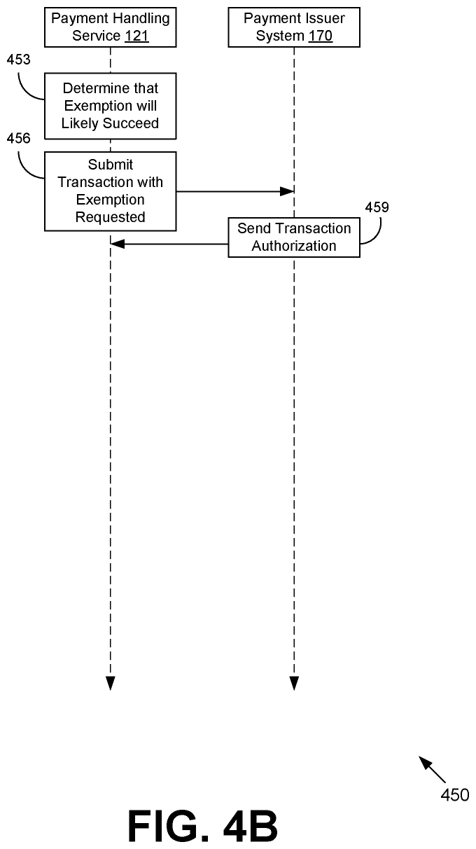

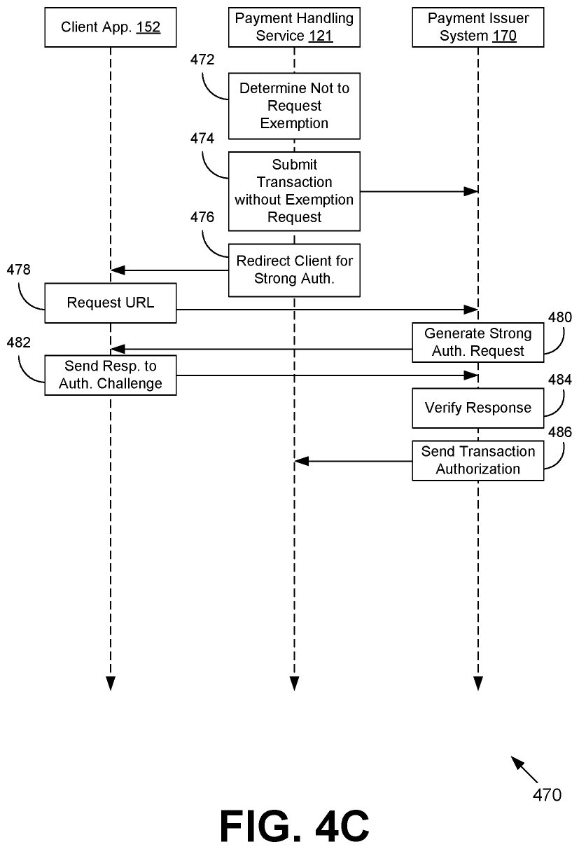

Referring next to FIG. 4A, shown is a sequence diagram 400 that provides an example of the interaction among the client application 152 (FIG. 1), the payment handling service 121 (FIG. 1), and the payment issuer system 170 (FIG. 1). It is understood that the sequence diagram 400 of FIG. 4A provides merely an example of the many different types of functional arrangements that can be employed to implement the operation of the depicted portions of the client application 152, the payment handling service 121, and the payment issuer system 170. As an alternative, the sequence diagram 400 of FIG. 4A can be viewed as depicting an example of elements of a method implemented within the network environment 100.

Beginning with box 403, the payment handling service 121 determines that for a given payment transaction 227 (FIG. 2), an exemption request 127 (FIG. 1) is likely to succeed. For example, a value associated with the payment transaction 227 may be below a maximum threshold 224 (FIG. 2) for a fraud rate 212 associated with the corresponding payment issuer. Further, the risk score generated by a risk management service 119 (FIG. 1) may be below a maximum risk threshold for the exemption. Finally, the exemption prediction service 123 may make a prediction that the exemption request 127 is likely to succeed based at least in part on an exemption success machine learning model 218 (FIG. 2) and/or the exemption success rules 221 (FIG. 2). In box 406, the payment handling service 121 submits a payment transaction processing request 125 (FIG. 1) via the network 109 (FIG. 1) to the payment issuer system 170 (FIG. 1) with an exemption request 127.

In box 409, the payment issuer system 170 denies the payment transaction 227 based at least in part on the exemption request 127 (FIG. 1). For example, the payment issuer system 170 may not support the specific exemption or the payment issuer system 170 may not allow the exemption on the basis of one or more parameters relating to the payment transaction 227 as specified in the payment transaction processing request 125. In one scenario, the payment issuer system 170 may have an internal risk evaluation system that may determine that the payment transaction 227 has an unacceptable risk without further authentication. The payment issuer system 170 sends data indicating the authorization denial back to the payment handling system 121 via the network 109 and possibly through one or more payment processing gateways.

In box 412, the payment handling service 121 submits the payment transaction processing request 125 again to the payment issuer system 170 but this time without the exemption request 127. In box 415, the payment handling service 121 redirects the client application 152 to complete a strong authentication process with the payment issuer system 170. To this end, the payment handling service 121 may send a strong authentication redirect 128 (FIG. 1) to the client application 152 via the network 109. The strong authentication redirect 128 may include network content with an iframe element.

In box 418, as a result of the strong authentication redirect 128, the client application 152 requests a uniform resource locator (URL) associated with the payment issuer system 170. In box 421, the payment issuer system 170 generates a strong authentication request 129 (FIG. 1), which is sent via the network 109 to the client application 152. The client application 152 may then render a user interface 154 (FIG. 1) on the display 150 to present the strong authentication request 129. The user may enter an answer to an authentication challenge in the strong authentication request 129, e.g., by answering a question via a voice interface, selecting one of multiple buttons in the user interface 154, entering text in a form, or by another approach.

In box 424, the client application 152 sends the response to the authentication challenge to the payment issuer system 170 via the network 109. In box 427, the payment issuer system 170 verifies that the response is a correct response to the authentication challenge. In box 430, the payment issuer system 170 sends a transaction authorization to the payment handling service 121. Thereafter, the sequence diagram 400 ends.

Continuing to FIG. 4B, shown is a sequence diagram 450 that provides another example of the interaction among the payment handling service 121 (FIG. 1), and the payment issuer system 170 (FIG. 1). It is understood that the sequence diagram 450 of FIG. 4B provides merely an example of the many different types of functional arrangements that can be employed to implement the operation of the depicted portions of the payment handling service 121, and the payment issuer system 170. As an alternative, the sequence diagram 450 of FIG. 4B can be viewed as depicting an example of elements of a method implemented within the network environment 100.

Beginning with box 453, the payment handling service 121 determines that for a given payment transaction 227 (FIG. 2), an exemption request 127 (FIG. 1) is likely to succeed. For example, a value associated with the payment transaction 227 may be below a maximum threshold 224 (FIG. 2) for a fraud rate 212 associated with the corresponding payment issuer. Further, the risk score generated by a risk management service 119 (FIG. 1) may be below a maximum risk threshold for the exemption. Finally, the exemption prediction service 123 may make a prediction that the exemption request 127 is likely to succeed based at least in part on an exemption success machine learning model 218 (FIG. 2) and/or the exemption success rules 221 (FIG. 2). In box 456, the payment handling service 121 submits a payment transaction processing request 125 (FIG. 1) via the network 109 (FIG. 1) to the payment issuer system 170 (FIG. 1) with an exemption request 127.

In box 459, the payment issuer system 170 approves the exemption request 127 so that no strong customer authentication is required, and then sends a transaction authorization to the payment handling service 121. Thereafter, the sequence diagram 450 ends.

Moving on to FIG. 4C, shown is a sequence diagram 470 that provides another example of the interaction among the client application 152 (FIG. 1), the payment handling service 121 (FIG. 1), and the payment issuer system 170 (FIG. 1). It is understood that the sequence diagram 470 of FIG. 4C provides merely an example of the many different types of functional arrangements that can be employed to implement the operation of the depicted portions of the client application 152, the payment handling service 121, and the payment issuer system 170. As an alternative, the sequence diagram of FIG. 4C can be viewed as depicting an example of elements of a method implemented within the network environment 100.

Beginning with box 472, the payment handling service 121 determines not to submit an exemption request 127 (FIG. 1) for a given payment transaction 227 (FIG. 2). For example, a value associated with the payment transaction 227 may be above a maximum threshold 224 (FIG. 2) for a fraud rate 212 associated with the corresponding payment issuer. Further, the risk score generated by a risk management service 119 (FIG. 1) may be above a maximum risk threshold for the exemption. Finally, the exemption prediction service 123 may make a prediction that the exemption request 127 is not likely to succeed based at least in part on an exemption success machine learning model 218 (FIG. 2) and/or the exemption success rules 221 (FIG. 2). In box 474, the payment handling service 121 submits a payment transaction processing request 125 (FIG. 1) via the network 109 (FIG. 1) to the payment issuer system 170 (FIG. 1) without an exemption request 127.

In box 476, the payment handling service 121 redirects the client application 152 to complete a strong authentication process with the payment issuer system 170. To this end, the payment handling service 121 may send a strong authentication redirect 128 (FIG. 1) to the client application 152 via the network 109. The strong authentication redirect 128 may include network content with an iframe element.

In box 478, as a result of the strong authentication redirect 128, the client application 152 requests a uniform resource locator (URL) associated with the payment issuer system 170. In box 480, the payment issuer system 170 generates a strong authentication request 129 (FIG. 1), which is sent via the network 109 to the client application 152. The client application 152 may then render a user interface 154 (FIG. 1) on the display 150 to present the strong authentication request 129. The user may enter an answer to an authentication challenge in the strong authentication request 129, e.g., by answering a question via a voice interface, selecting one of multiple buttons in the user interface 154, entering text in a form, or by another approach.

In box 482, the client application 152 sends the response to the authentication challenge to the payment issuer system 170 via the network 109. In box 484, the payment issuer system 170 verifies that the response is a correct response to the authentication challenge. In box 486, the payment issuer system 170 sends a transaction authorization to the payment handling service 121. Thereafter, the sequence diagram 470 ends.

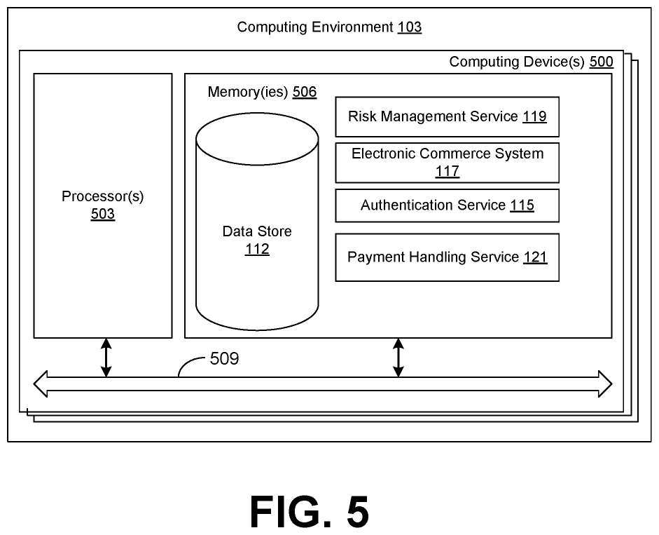

With reference to FIG. 5, shown is a schematic block diagram of the computing environment 103 according to an embodiment of the present disclosure. The computing environment 103 includes one or more computing devices 500. Each computing device 500 includes at least one processor circuit, for example, having a processor 503 and a memory 506, both of which are coupled to a local interface 509. To this end, each computing device 500 may comprise, for example, at least one server computer or like device. The local interface 509 may comprise, for example, a data bus with an accompanying address/control bus or other bus structure as can be appreciated.

Stored in the memory 506 are both data and several components that are executable by the processor 503. In particular, stored in the memory 506 and executable by the processor 503 are the risk management service 119, the electronic commerce system 117, the authentication service 115, the payment handling service 121, and potentially other applications. Also stored in the memory 506 may be a data store 112 and other data. In addition, an operating system may be stored in the memory 506 and executable by the processor 503.

It is understood that there may be other applications that are stored in the memory 506 and are executable by the processor 503 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 506 is defined herein as including both volatile and nonvolatile memory and data storage components. Volatile components are those that do not retain data values upon loss of power. Nonvolatile components are those that retain data upon a loss of power. Thus, the memory 506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 503 may represent multiple processors 503 and/or multiple processor cores and the memory 506 may represent multiple memories 506 that operate in parallel processing circuits, respectively. In such a case, the local interface 509 may be an appropriate network that facilitates communication between any two of the multiple processors 503, between any processor 503 and any of the memories 506, or between any two of the memories 506, etc. The local interface 509 may comprise additional systems designed to coordinate this communication, including, for example, performing load balancing. The processor 503 may be of electrical or of some other available construction.

Although the risk management service 119, the electronic commerce system 117, the authentication service 115, the payment handling service 121, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3A-3C show the functionality and operation of an implementation of portions of the payment handling service 121 and the exemption prediction service 123, and the sequence diagrams of FIGS. 4A-4C show the functionality and implementation of the client application 152 (FIG. 1), the payment handling service 121, and the payment issuer system 170 (FIG. 1). If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 503 in a computer system or other system. The machine code may be converted from the source code, etc. If embodied in hardware, each block may represent a circuit or a number of interconnected circuits to implement the specified logical function(s).

Although the flowcharts of FIGS. 3A-3C and the sequence diagrams of FIGS. 4A-4C show a specific order of execution, it is understood that the order of execution may differ from that which is depicted. For example, the order of execution of two or more blocks may be scrambled relative to the order shown. Also, two or more blocks shown in succession in FIGS. 3A-3C and FIGS. 4A-4C may be executed concurrently or with partial concurrence. Further, in some embodiments, one or more of the blocks shown in FIGS. 3A-3C and FIGS. 4A-4C may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the risk management service 119, the electronic commerce system 117, the authentication service 115, and the payment handling service 121, that comprises software or code can be embodied in any non-transitory computer-readable medium for use by or in connection with an instruction execution system such as, for example, a processor 503 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the risk management service 119, the electronic commerce system 117, the authentication service 115, and the payment handling service 121, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 500, or in multiple computing devices 500 in the same computing environment 103.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A non-transitory computer-readable medium embodying a program executable in at least one computing device, wherein when executed the program causes the at least one computing device to at least:
authenticate a user associated with a payment transaction;
identify a card issuer associated with a payment card utilized in the payment transaction;
determine that a value associated with the payment transaction is below a minimum value threshold corresponding to the card issuer and to a fraud rate associated with the card issuer;
determine, via a risk analysis, that a risk score associated with the payment transaction meets a risk threshold;
submit the payment transaction for processing by the card issuer with a request for an exemption from an authentication requirement; and
update at least one rule for determining whether to submit the request for the exemption from the authentication requirement based at least in part on whether the payment transaction was successfully processed by the card issuer.

2. The non-transitory computer-readable medium of claim 1, wherein when executed the program further causes the at least one computing device to at least refrain from generating a redirection to a uniform resource locator (URL) associated with the authentication requirement in response to submitting the payment transaction for processing with the request for the exemption.

3. The non-transitory computer-readable medium of claim 1, wherein the exemption is a Transaction Risk Analysis exception in which a payee entity assumes responsibility for a liability associated with the payment transaction in response to the exemption from the authentication requirement, and the authentication requirement is a Strong Customer Authentication requirement in which the card issuer requires that a user respond to at least one authentication challenge by the card issuer.

4. The non-transitory computer-readable medium of claim 1, wherein when executed the program further causes the at least one computing device to at least determine whether to submit the request for the exemption for a subsequent payment transaction with the card issuer for another user based at least in part on the at least one rule that has been updated.

5. A method, comprising:
submitting, via at least one of one or more computing devices, a first payment transaction associated with a first user for processing by a particular payment issuer, the first payment transaction being submitted with a request for an exemption from an authentication requirement;
determining, via at least one of the one or more computing devices, whether the first payment transaction was successfully processed; and
determining, via at least one of the one or more computing devices, whether to include the request for the exemption from the authentication requirement for a second payment transaction associated with a second user in submitting the second payment transaction for processing with the particular payment issuer based at least in part on whether the first payment transaction was successfully processed.

6. The method of claim 5, further comprising in response to determining that the first payment transaction was not successfully processed, submitting, via at least one of the one or more computing devices, the first payment transaction for processing by the particular payment issuer without the request for the exemption from the authentication requirement.

7. The method of claim 5, further comprising:
identifying, via at least one of the one or more computing devices, the particular payment issuer by determining that a payment instrument number used in the first payment transaction is within a range of payment instrument numbers associated with the particular payment issuer; and
determining, via at least one of the one or more computing devices, that the particular payment issuer does not support the exemption from the authentication requirement based at least in part on determining that the first payment transaction was not successfully processed.

8. The method of claim 5, further comprising determining, via at least one of the one or more computing devices, that a value of the first payment transaction is at or below a maximum value threshold for the exemption from the authentication requirement before submitting the first payment transaction with the request for the exemption from the authentication requirement.

9. The method of claim 5, further comprising determining, via at least one of the one or more computing devices, based at least in part on a risk analysis performed on the first payment transaction, that a risk score for the first payment transaction meets a risk threshold before submitting the first payment transaction with the request for the exemption from the authentication requirement.

10. The method of claim 5, further comprising authenticating, via at least one of the one or more computing devices, the first user by a merchant-specific authentication process before submitting the first payment transaction with the request for the exemption from the authentication requirement.

11. The method of claim 5, further comprising training, via at least one of the one or more computing devices, a machine learning model for predicting a successful exemption from the authentication requirement for the particular payment issuer based at least in part on whether the first payment transaction was successfully processed, at least one characteristic of the first payment transaction, and at least one characteristic of the first user.

12. The method of claim 11, wherein determining whether to include the request for the exemption from the authentication requirement for the second payment transaction in submitting the second payment transaction for processing with the particular payment issuer is further based at least in part on the machine learning model.

13. The method of claim 5, wherein the authentication requirement comprises at least one authentication challenge performed by the particular payment issuer.

14. A system, comprising:
at least one computing device; and
a payment handling service executable in the at least one computing device, wherein when executed the payment handling service causes the at least one computing device to at least:
train a machine learning model to predict whether a particular payment issuer supports an exemption from an authentication requirement based at least in part on a plurality of past payment transactions associated with a plurality of users that have been submitted for processing with a request for the exemption; and
determine whether to include the request for the exemption for a particular payment transaction associated with a particular user based at least in part on the machine learning model.

15. The system of claim 14, wherein the machine learning model is specific to the particular payment issuer.

16. The system of claim 14, wherein the authentication requirement corresponds to an authentication challenge presented to a client device by a system operated by the particular payment issuer.

17. The system of claim 14, wherein the machine learning model is trained further based at least in part on at least one characteristic of a respective user of the plurality of users corresponding to a respective past payment transaction of the plurality of past payment transactions.

18. The system of claim 14, wherein determining whether to include the request for the exemption for the particular payment transaction is performed in response to determining that a value associated with the particular payment transaction is at or below a maximum value threshold.

19. The system of claim 18, wherein the maximum value threshold is determined based at least in part on a fraud rate associated with the particular payment issuer.

20. The system of claim 14, wherein when executed the payment handling service further causes the at least one computing device to at least update the machine learning model based at least in part on a result of the particular payment transaction when the particular payment transaction is submitted with the request for the exemption.
